(19) United States
(12) Patent Application Publication
(10) Pub. No.: US 2006/0050294 A1
(43) Pub. Date: Mar. 9, 2006

(54) Method and system for managing the distribution of print job files among shared printers on a computer network

(75) Inventors: Mark A. Smith, Rochester, NY (US); Ammar T. Degani, Pittsford, NY (US); Kaushik Chaudhuri, Rochester, NY (US)

Correspondence Address: Paul J. Maginot;MAGINOT, MOORE & BECK LLP, Bank One Center/Tower, 111 Monument Circle, Suite 3000, Indianapolis, IN, 46204-5115, US

(73) Assignee: Xerox Corporation

(21) Appl. No.: 10/936,105

(22) Filed: Sep. 8, 2004

(51) Int. Cl. G06F 3/12

(52) U.S. Cl. 358/1.15

(57) ABSTRACT

A system and method support load balancing for print jobs on a peer-to-peer network. The system incorporates a job forwarding query manager and a printer controller selector in a printer controller. The query manager detects a condition for forwarding a print job and generates queries to alternative printer controllers for available logical printers. The responses contain logical printer characteristics and load measurements for logical printers that are capable of processing and printing the forwarded print job. The printer controller selector determines which logical printer has the characteristics necessary to print the print job and the least load. The attributes of the print job are merged with the logical printer attributes of the logical printer at the querying controller to ensure correcting printing of the forwarded print job by the logical printer to which the print job is forwarded. If no logical printer has the characteristics required for printing a print job, the printer controller selector determines whether the missing characteristic can be downloaded to the alternative printer controller to which the logical printer is coupled. If the characteristic can be downloaded, the printer controller selector sends the characteristic to the alternative printer controller for installation on the logical printer and forwards the print job to the alternative printer controller upon confirmation that the characteristic has been successfully installed.

### FIELD OF THE INVENTION

The present invention relates generally to print job management systems, and more particularly, to print job management systems for shared printers on a computer network.

### BACKGROUND OF THE INVENTION

Computer communication networks enable multiple computers to communicate with one another to facilitate the exchange of information and to increase productivity. These networks are also used to couple resources to the computers so that the resources are shared and thus, more efficiently used. For example, a printer is a commonly shared resource on a computer network. By communicating print jobs from multiple computers to a commonly shared printer for output, a number of advantages are gained. For one, each computer no longer requires its own dedicated printer for the output of documents. This reduction in the number of printers required to support multiple computers may represent a significant financial savings for an organization. Additionally, the expense of maintaining and providing supplies for printers is reduced because the sharing of printer resources reduces the number of printers that need to be maintained by the organization.

Another benefit of sharing a printer on a computer network is that the printer is used more efficiently. When a printer is not printing a document, it is drawing power for no apparent purpose other than to be ready for printing a document. By coupling multiple computers to a printer, the printer is likely to process more jobs than if it was only coupled to a single computer. Consequently, the printer produces more documents over its life than if it was coupled to one computer only.

A typical network printing system comprises a plurality of different printers, client computers, and other network components coupled together on a network. On a client/server network, a client computer generates a print job that is sent to a printer controller server. The printer controller server determines whether a compatible logical printer is available for processing a print job. A logical printer receiving a print job processes the print job to generate a bit-mapped image file, sometimes called a raster file, which is placed in a queue for printing by a physical printer. In a peer-to-peer network, one or more printers have an associated printer controller that accepts print jobs from clients, processes them to produce a bit-mapped image file, and then directs the file to a compatible printer for printing.

Printers that are shared over a network typically differ in their state capabilities and characteristics. Some printers may be high speed so that large volume jobs may be processed and printed by the printer with nominal time spent waiting for a document to be printed. Other printers may provide color capabilities or be stocked with a variety of unusual stock sizes. Varying the types of printers coupled to a network makes a wide range of printing options available to the network users.

Although there are significant benefits to the coupling of multiple computers to a variety of shared printers having different capabilities, there are some drawbacks as well. To address these drawbacks, a printer controller server in a client/server network may include a print job manager that balances the processing loads for different printers coupled to the printer controller server in an effort to prevent over-utilization of one or more printers. Typically, a print job manager on a printer controller server includes a plurality of virtual or logical printers instantiated on the printer controller server. These logical printers are comprised of data objects with which a user may interact over the network to ascertain printer capabilities or to identify job attributes for a print job. The virtual printers of a print job manager receive print job tickets that are generated by the clients on the computer network. A job ticket is a data structure that identifies the user requesting the printer, the digital document to be printed, and the attributes of the print job to be performed, such as the paper size, font requirements, and other printing parameters. The print job manager directs print jobs to different queues to more evenly distribute the load among the printers coupled to the printer controller server that are capable of printing the requested jobs. The management of printer queues may be based on a number of factors including user priorities, the size of the job, the capabilities of the printers, and the order in which the print jobs are received. In this type of client/server network, multiple users may send documents to the same logical printer, which may cause it to become over-utilized and delay generation of the document. The print job manager addresses this problem by determining whether another printer coupled to the printer controller server can perform the print job and directing the job to that printer.

In a peer-to-peer network, however, a user of a client computer selects a logical printer of a printer controller to process a print job based on a match of the print job attributes to the printer capabilities. Because the print controller only controls the printers coupled to it, a job may be processed and placed in queue for a physical printer that is over-utilized. Meanwhile, another controller on the network may be coupled to a printer that is capable of processing and printing the job that is currently under-utilized. Unless the user of the client computer queries the logical printers of each printer controller, under-utilized printers may not be detected. If a user is required to query each controller, then the user's time to select a logical printer for each print job is increased. Thus, either user time or printer resources on the peer-to-peer network are not being efficiently used.

Another problem arising from different types of printers being shared on a network is the incompatibility of some printers with some print jobs. As long as at least one printer that possesses the necessary capabilities and characteristics for processing and printing a submitted print job is coupled to the network, this incompatibility does not adversely impact the performance of the network. However, if a particular characteristic is required by a number of documents being printed at the same time, that printer's queue may fill and delay document processing on the network. Thus, other printers may be available on the network, but the lack of the required characteristic precludes these otherwise available printers from being used.

### SUMMARY OF THE INVENTION

The present invention addresses the need for managing printer resources on a peer-to-peer network, as well as other needs, by providing a method and system for exchanging print jobs between printer controllers to better balance the print job load across multiple printer controllers without requiring a central controller. In a system and method implemented in accordance with the principles of the present invention, the printer controllers communicate with one another to perform distributed load balancing. In one embodiment of the present invention, a printer controller has a data structure that identifies a list of alternative printer controllers. In response to a printer controller detecting a condition for forwarding a print job, the printer controller queries each alternative printer controller for logical printers capable of processing and printing the print job. The printer controller includes in this query, a file containing the print job attributes for the requested print job so that each alternative printer controller is able to determine whether at least one printer having the capability to print the print job is available at the alternative printer controller. Each controller returns a message identifying the characteristics of the printer at the controller, if any, that is capable of processing the print job and the current load of each capable printer. The querying print controller then selects the printer controller having a printer capable of processing the print job that is the least utilized. The printer controller then forwards the print job to the selected printer controller and informs the requesting client computer that the job has been forwarded. Status information regarding the processing of the print job is relayed by the querying controller from the processing printer controller to the client computer.

In one embodiment of the present invention, a system administrator of the network defines the list of alternative printer controllers that a printer controller may query to locate alternative printers for processing a print job. The list of alternative printer controllers may be defined in accordance to their physical locations. In this manner, the printers that may be used to process and print a user's print jobs may be located within the same building or facility. However, other factors may be used by the system administrator for defining the list of alternative printer controllers.

In one embodiment of the present invention, the load for a logical printer may be quantified by the number of jobs already in a queue associated with a printer or by the size of the jobs in the queue. Other measurements may be used to evaluate printer load, such as the time to print the jobs pending in a queue, stock sheets available in a supply tray, or toner level. The load measurement is a parameter or set of parameters that the querying printer controller may use to determine which printer capable of successfully completing the requested print job is least utilized.

Another aspect of the present invention is the processing of the characteristics returned to the querying printer controller. The printer controller may determine that no capable logical printer has every characteristic required for processing a print job. However, a comparison of the returned printer characteristics with the list of characteristics required for processing and printing the print job may indicate that the only characteristics that are missing from a capable logical printer are characteristics that can be downloaded from the querying printer controller. For example, the comparison may indicate that the logical printer corresponding to the returned printer characteristics does not have a font or a procedure set that is required for the print job. The querying printer controller, in response, downloads the font or procedure set to the alternative printer controller and forwards the job to the alternative printer controller upon confirmation that the characteristic has been successfully downloaded and installed in the logical printer. In this manner, the characteristics of logical printers on the network may be enhanced to handle more print jobs and increase the bandwidth for processing print jobs on the network. A log of the transfer of the font or procedure set may obtained by the system administrator to update records regarding the characteristics of the logical printers coupled to the network.

In another aspect of the current invention, the querying printer controller merges the logical printer attributes of the querying controller with the job attributes for the print job. The querying controller also modifies the print job to override the logical printer attributes of the logical printer at an alternative printer controller so the logical printer does not change the programming of the print job. This aspect enables the print job to be processed and printed by the logical printer at the alternative printer controller with printer attributes that match those of the printer at the printer controller to which the print job was originally directed. This reduces the likelihood of inadvertent change in the output because of differences in the logical printers of the two printer controllers. When this aspect of the present invention is combined with the feature for downloading a missing logical printer characteristic, it helps ensure that the logical printer coupled to the alternative printer controller produces printed output that matches the printed output that would have been generated by the logical printer to which the print job was originally directed.

The system and method of the present invention enable the printer controllers of a peer-to-peer network to balance the load on printers in the network even though the printers are coupled to the network through different printer controllers. Additionally, more printers are made available for processing print jobs because the print controllers are able to download characteristics, such as fonts and/or procedure sets, to enlarge the set of printers for processing print jobs. To ensure that the output images remain the same as those that would be produced at the querying controller, the querying controller merges the logical printer attributes of the logical printer at the querying controller with the attributes of the print job and then modifies the print job to override the logical printer attributes of the logical printer to which the print job is being forwarded.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a block diagram of a network in which the system and method of the present invention may be implemented;

FIG. 2 shows a block diagram of a printer controller in which the system and method of the present invention may be implemented;

FIG. 3 is a block diagram of the job forwarding module shown in the printer controller of FIG. 2;

FIG. 4A is a flow diagram of an example of a process for balancing print job loads on a peer-to-peer network in accordance with the principles of the present invention;

FIG. 4B is a flow diagram of an example of a process for modifying the process of FIG. 4A so that the process modifies a print job file so that the attributes of the print job file override the attributes of the logical printer at the alternative printer controller to which a print job is being forwarded; and

FIG. 5 is a flow diagram of another example of a process for balancing job loads on a peer-to-peer network that also modifies the characteristics of another logical printer on the network before forwarding a print job to it.

### DETAILED DESCRIPTION

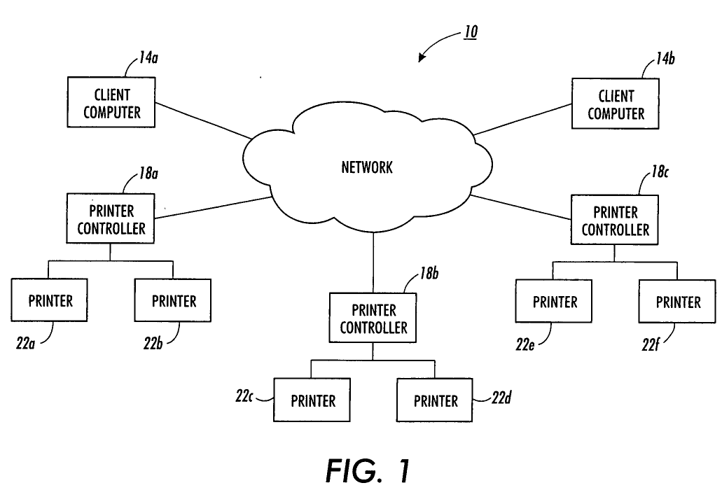

FIG. 1 shows an example of a peer-to-peer network 10 in which the principles of the present invention may be implemented. Network 10 includes a plurality of client computers 14a and 14b, printer controllers 18a, 18b, and 18c, and printers 22a, 22b, 22c, 22d, 22e, and 22f. The printer controllers 18a, 18b, and 18c are computers with memory and other components that operate under the control of programmed instructions to communicate with the client computers 14a and 14b and to manage the printers 22a-22f coupled to each controller. Each controller may have one or more logical or virtual printers executing in it for processing print jobs received from the client computers. The logical printers process a print job data file to transform, for example, a print job data file into an image file or the logical printer may use a daemon for that purpose. The network coupling the controllers and client computers may be comprised of any suitable network architecture, such as LAN, Ethernet, WAN, System Area Network (SAN), Token Ring, LocalTalk, or TCP/IP network schemes. Such a network may be used, for example, in a document production environment in which the client computers are operator workstations for sending print jobs to printer controllers on a peer-to-peer network.

In previously known systems, the client computers send print jobs to a logical printer on one of the printer controllers. The logical printer processes the print job to generate a bit-mapped image file that is placed in a queue managed by the printer controller for one of the printers coupled to the printer controller. When the print image file is released from the queue, it is directed to the printer to which the queue is associated and printed. Thus, the printer controller may only use the printers coupled to the printer controller.

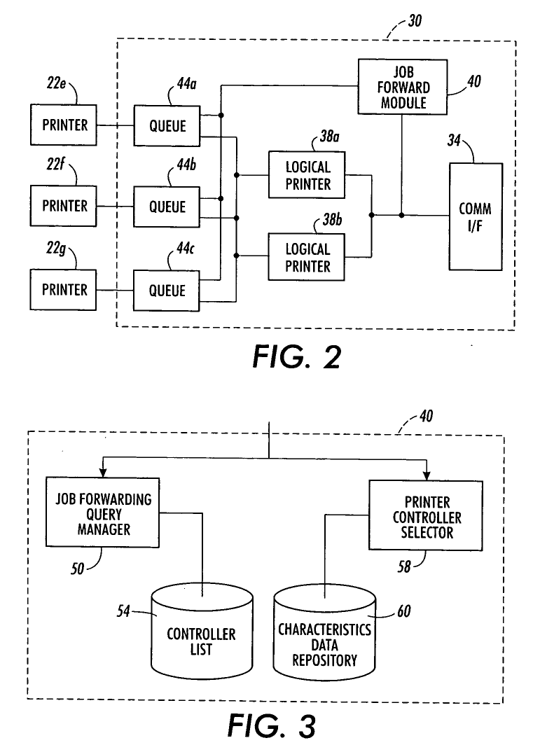

In a system and method implemented in accordance with the principles of the present invention, the printer controllers on a peer-to-peer network communicate with one another to perform distributed load balancing. A printer controller that implements the principles of the present invention is shown in FIG. 2. The printer controller 30 includes a communication interface 34, logical printers 38a and 38b, a job forwarding module 40, and printer queues 44a, 44b, and 44c. The communication interface 34 communicates with client computers and other printer controllers over the network. The logical printers operate as previously known logical printers to process a print job and generate an image file that is delivered to one of the queues 44a, 44b, or 44c. A printer controller may instantiate one or more logical printers at a time, but only two are shown in FIG. 2 to simply the drawing and description. The image files generated by the logical printers are directed to the queue for the physical printer 22e, 22f, or 22g that will print the image file, and an image file is released to a physical printer as the printer becomes available for printing a job. The job forwarding module 40 receives the print job messages from the client computers and status data from the queue(s) 44 to determine whether a print job should be forwarded.

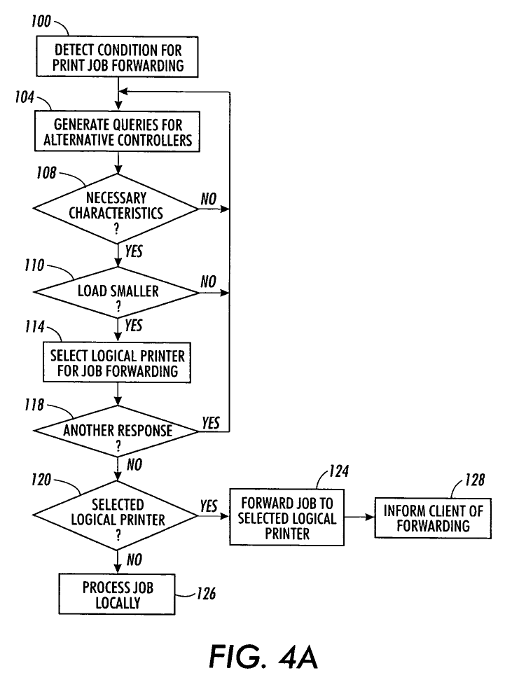

The job forwarding module 40 is shown in more detail in FIG. 3. The job forwarding module 40 includes a job forwarding query manager 50, a controller list 54, a printer controller selector 58, and a characteristics data repository 60. The controller list 54 is a data structure that identifies a list of alternative printer controllers. In response to the job forwarding query manager 50 detecting a condition, such as an over-utilized printer, that requires forwarding of the print job to a logical printer on an alternative printer controller, the job forwarding query manager 50 accesses the controller list 54 and generates queries for each alternative printer controller identified in the list. The printer controller selector 58 receives the print job attributes from the logical printer 38 and provides them to job forwarding query manager 50. The job forwarding query manager 50 includes the print job attributes for the requested print job in each query so that each alternative printer controller is able to determine whether a printer having the capability for performing the print job is available at the alternative printer controller.

Each alternative printer controller returns a message to the job forwarding query manager 50 identifying the characteristics of the logical printers at the alternative printer controller that are capable of processing the print job, if any, and the current load of the capable printer(s). The job forwarding query manager 50 provides the returned data to the printer controller selector 58 and the selector 58 selects the alternative printer controller with a printer that is the least utilized that also has the capability of printing the job. In one aspect of the present invention, the printer controller selector 58 provides the print job to the job forwarding query manager 50 for sending to the selected printer controller. The job forwarding query manager 50 also informs the requesting client computer that the job has been forwarded. Thereafter, the printer controller to which the job is forwarded provides status information regarding the processing of the print job to the job forwarding query manager 50 so it may be relayed to the client computer.

In one embodiment of the present invention, a system administrator of the network defines the list of alternative printer controllers that a printer controller may query to locate alternative printers for processing a print job. The list of alternative printer controllers may be defined in accordance to their locations. In this manner, the printers that may be used to process and print a user's print jobs may be constrained to those located within the same building or facility. However, other factors may be used by the system administrator for defining the list of alternative printer controllers. In another embodiment of the present invention, each printer controller broadcasts its identifier and location or other associated data at the time that the network or printer controller is initialized. Using this data, each printer controller may build its own data structure to store data regarding the printer controllers on the peer-to-peer network. Any constraints imposed by a user at a client computer for selecting alternative controllers may also be transferred to the printer controller via the network and incorporated within the controller list.

In one embodiment of the present invention, the load for a logical printer may be quantified by the number of jobs already in a queue associated with a printer or by the size of the jobs in the queue. Other load measurements may be used, such as the time to print the jobs pending in a queue, stock sheets available in a supply tray, or toner level. The load measurement is a parameter or set of parameters that the querying printer controller may use to determine which capable printer is least utilized.

The printer controller selector 58 may also process the print job so that the logical printer attributes of the logical printer to which the job is forwarded do not override the attributes of the job. For this aspect of the present invention, the printer controller selector 58 retrieves the logical printer attributes of the logical printer 38 and merges them with the job attributes for the print job. The printer controller selector then modifies the print job file so that the print job attributes override the logical printer attributes to be used by the logical printer at the selected printer controller. This aspect ensures that the forwarding of the print job to another controller having a logical printer with the same characteristics for processing the job as the logical printer at the querying controller produces the same output. This reduces the likelihood of inadvertent change in the output because of differences between the logical printers of the two printer controllers.

The printer controller selector 58 may also process the responses of the queried printer controllers and then enhance the characteristics of the logical printer at a selected printer controller. The printer controller selector compares the logical printer characteristics returned from a queried controller with the list of characteristics required for the performing the print job. If a logical printer lacks only characteristics that can be downloaded from the printer controller, the printer controller selector 58 retrieves files for those characteristics from the characteristics data repository 60 and sends them to the job forwarding query manager 50. These characteristics are then communicated to the corresponding printer controller for installation in the logical printer.

Upon confirmation of successful installation of the logical printer characteristic(s), the querying printer controller forwards the job to the selected logical printer on the alternative printer controller. For example, the comparison may indicate that the logical printer corresponding to the returned printer characteristics does not have a font or a procedure set that is required for the print job. The printer controller selector 58, in response, obtains the font or procedure set from the characteristics data repository and provides it to the job forwarding query manager. The job forwarding query manager downloads the font or procedure set to the alternative printer controller and selects a logical printer on the alternative printer controller for the job upon confirmation that the font has successfully downloaded. In this manner, the characteristics of printers on the network may be enhanced to handle more print jobs and increase the bandwidth for processing print jobs on the network. A log of the transfer of the font or procedure set may obtained by the system administrator to update records regarding the characteristics of the printers coupled to the network.

Thus, the job forwarding module of the present invention enables the print controllers of a peer-to-peer network to balance the load on printers in the network even though they are coupled to the network through different printer controllers. Additionally, more printers are made available for processing print jobs because the print controllers are able to download fonts and/or procedure sets to enhance the set of characteristics for available logical printers. To ensure that the output images remain the same as those that would be produced at the querying controller, the printer controller selector 58 merges the logical printer attributes of the logical printer at the querying controller with the attributes of the print job and then modifies the print job file to override the logical printer attributes of the selected logical printer. When the techniques for preserving the logical printer attributes of a logical printer are combined with the feature for downloading a missing printer characteristic, safeguards are provided for ensuring that the logical printer receiving the forwarded print job prints it in the same way that the logical printer to which the job was originally directed would have printed the job.

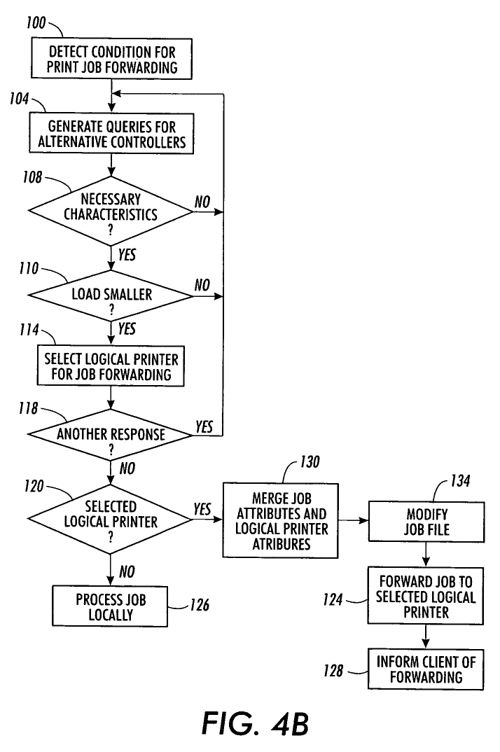

A method of the present invention may be performed, for example, as shown in FIG. 4A. The process detects a condition for forwarding a print job (block 100). For example, the logical printer to which the print job was originally sent may be over-utilized. Queries for alternative printer controllers to print the job are generated (block 104). Each of the responses identifying the capable logical printers' characteristics and their printer loads are parsed to determine whether one of the logical printers has the characteristics necessary for processing and printing the job (block 108). If a logical printer identified in a response does not have the necessary characteristics, the next response is parsed. If the printer is capable, the process determines whether that logical printer's load is less than any previously selected logical printer (block 110). If it is not smaller, the next response is parsed. If a logical printer identified in a response has the necessary characteristics for processing and printing a job and its load is the smallest yet encountered, the logical printer is selected for forwarding (block 114). The process determines whether other responses require parsing (block 118), and if there are other responses, they are parsed (blocks 108-114). Once all the blocks are parsed, the process determines whether a logical printer was selected (block 120). If one was not, then the print job processing continues locally with the over-utilized logical printer (block 126). However, if a logical printer coupled to an alternative printer controller was selected, the print job is forwarded to the selected logical printer for processing (block 124). The client that submitted the print job is informed that the print job has been forwarded for processing (block 128).

A modification to the process of FIG. 4A is shown in FIG. 4B. This modification occurs after the process has determined that a logical printer has been selected to process the print job (block 120). The process merges the job attributes and the logical printer attributes of the logical printer to which the print job was originally sent (block 130). The process also modifies the job file so that the modified attributes in the job file override those of the logical printer to which the print job is forwarded (block 134). The process then continues by forwarding the print job to the selected logical printer (block 124) and the client is informed that the job has been forwarded (block 128).

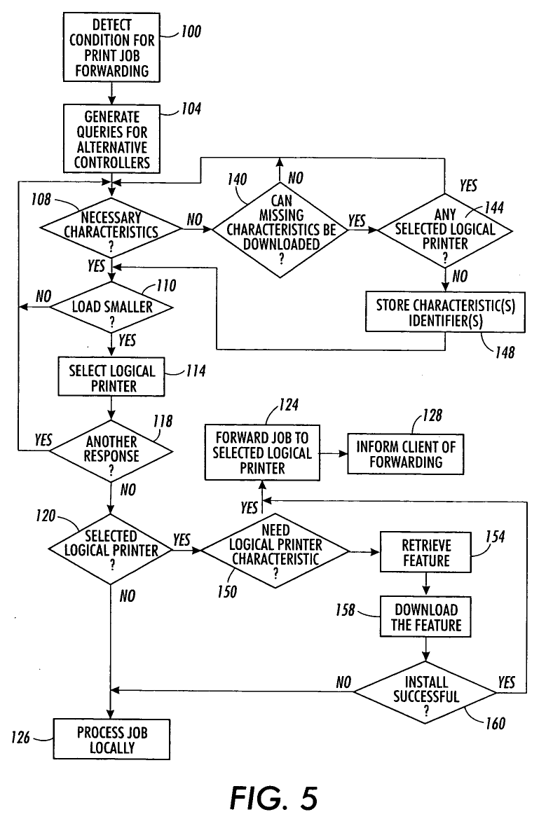

Another process for performing the principles of the present invention, for example, is shown in FIG. 5. Using like numerals for like processing, the process detects a condition for forwarding a print job to an alternative printer controller (block 100). Queries for alternative printer controllers to print the job are generated (block 104). Each of the responses identifying the logical printer characteristics and printer loads are parsed to determine whether a logical printer has the necessary characteristics for processing and printing the job (block 108). If a logical printer identified in a response does not have the necessary characteristics, the process determines whether the missing characteristic(s) can be downloaded to the logical printer identified in the response from an alternative printer controller (block 140). If the characteristic(s) cannot be downloaded, the next response is parsed. If the characteristic(s) can be downloaded, the process determines whether a logical printer has already been selected that does not require a characteristic to be downloaded (block 144). If such a logical printer has been found in the responses, the process parses the next response. Otherwise, the identifier(s) of the missing characteristics that can be downloaded are stored in association with the logical printer (block 148) and the process determines whether that logical printer's load is less than any previously selected logical printer (block 110). If it is not smaller, the next response is parsed. If the logical printer has a load that is the smallest yet encountered, the logical printer is selected for forwarding (block 114). The process determines whether other responses require parsing (block 118), and if there are other responses, they are parsed (blocks 108-114 and blocks 140-148).

Once all the blocks are parsed, the process determines whether a logical printer was selected (block 120). If one was not, then the print job processing continues locally with the logical printer to which the print job was originally sent (block 126). However, if a logical printer was selected, the process determines whether the selected logical printer requires one or more printer characteristics to be downloaded (block 150). If the logical printer has the necessary characteristics, the print job is forwarded to the selected logical printer coupled to an alternative printer controller for processing (block 124). The client that submitted the print job is informed that the print job has been forwarded for processing (block 128). If a printer characteristic needs to be downloaded, the characteristic is retrieved from the characteristic data repository (block 154) and downloaded to the alternative printer controller to which the selected logical printer is coupled (block 158). If the alternative printer controller indicates that the one or more logical printer characteristics were successfully installed in the selected logical printer (block 160), the job is forwarded to the logical printer for processing (block 124) and the client is informed of the forwarding (block 128). Otherwise, the job is processed locally (block 126). Of course, the process of FIG. 5 may also be modified with the process of FIG. 4B so the logical printer attributes of the logical printer to which the job was originally sent override the logical printer attributes of the logical printer to which the print job was forwarded.

While the present invention has been illustrated by the description of exemplary processes and system components, and while the various processes and components have been described in considerable detail, applicant does not intend to restrict or in any way limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

What is claimed is:

1. A method for balancing print job loads for printers on a peer-to-peer network comprising:
detecting a condition for forwarding a print job;
generating queries for alternative printer controllers to print the print job;
selecting a logical printer coupled to an alternative printer controller for printing the print job from responses to the generated queries; and
forwarding the print job to the selected logical printer.

2. The method of claim 1, the generation of the queries further comprising:
selecting alternative printer controllers for which the queries are generated from a list of alternative printer controllers for a particular physical location.

3. The method of claim 1, further comprising:
parsing responses from the queried alternative printer controllers;
comparing logical printer characteristics in a response to characteristics of the logical printer to which the print job was sent; and
selecting a logical printer having characteristics capable of processing the print job.

4. The method of claim 3, further comprising:
comparing load measurements in the responses to the queries; and
selecting the logical printer having characteristics necessary for processing the print job and having the smallest load measurement.

5. The method of claim 4, further comprising:
communicating with a client that sent the detected print job to inform the client that the print job has been forwarded to the selected logical printer.

6. The method of claim 1, further comprising:
merging job attributes for the print job with logical printer attributes for the logical printer to which the print job was sent; and
modifying the print job to override the logical printer attributes of the selected logical printer.

7. The method of claim 3, further comprising:
identifying logical printer characteristics not in a response that can be downloaded to the alternative printer controller that sent the response.

8. The method of claim 7, further comprising:
downloading the identified logical printer characteristics to the alternative printer controller to which the logical printer is coupled.

9. The method of claim 8, further comprising:
confirming installation of the downloaded logical printer characteristics in the logical printer; and
forwarding the print job to the logical printer at the alternative printer controller in response to the confirmation.

10. A system for balancing print job loads for printers on a peer-to-peer network comprising:
a printer controller for receiving print jobs from client computers and processing them to generate image files for printers; and
a job forwarding module coupled to the printer controller, the job forwarding module for forwarding print jobs to alternative printer controllers in response to a condition for print job forwarding being detected.

11. The system of claim 10, the job forwarding module further comprising:
a job forwarding query manager for generating queries for alternative printer controllers to print the print job; and
a printer controller selector for selecting an alternative printer controller for printing the print job from responses to the generated queries.

12. The system of claim 11, further comprising:
storage for a list of alternative printer controllers for a particular physical location so that job forwarding query manager generates queries for alternative printer controllers in the list.

13. The system of claim 12, further comprising:
a characteristics data repository for storing logical printer characteristics; and
the printer controller selector comparing logical printer characteristics in responses from queried alternative printer controllers to characteristics retrieved from the characteristics data repository; and
selecting a logical printer having the characteristics retrieved from the characteristics data repository.

14. The system of claim 13 wherein the printer controller selector compares load measurements in the responses to the queries; and
selects the logical printer having the characteristics retrieved from the characteristics data repository.

15. The system of claim 14 wherein the job forwarding query manager communicates with a client that sent the detected print job to inform the client that the print job has been forwarded to the selected logical printer.

16. The system of claim 15 wherein the printer controller selector merges job attributes for the print job with logical printer attributes for the logical printer to which the print job was sent; and
modifies the print job to override the logical printer attributes of the selected logical printer.

17. The system of claim 13 wherein the printer controller selector identifies logical printer characteristics not in a response that can be downloaded to the alternative printer controller that sent the response; and
downloading the identified logical printer characteristics retrieved from the characteristics data repository to the alternative printer controller.

18. The system of claim 17 wherein the job forwarding query manager confirms installation of the downloaded logical printer characteristics; and
forwards the print job to the logical printer at the alternative printer controller in response to the confirmation.

19. A method for balancing print job loads for printers on a peer-to-peer network comprising:
receiving a print job at a printer controller for printing by a logical printer coupled to the printer controller;
detecting a condition for forwarding a print job;
generating queries for alternative printer controllers to print the print job; and
selecting a logical printer coupled to an alternative printer controller for printing the print job from responses to the generated queries.

20. The method of claim 19, further comprising:
retrieving the logical printer attributes for the logical printer coupled to the printer controller;
merging the retrieved logical printer attribures with the job attributes for the print job; and
modifying the print job to override the logical printer attributes of the selected logical printer.
